(19) United States
(12) Patent Application Publication
(10) Pub. No.: US 2026/0332774 A1
(43) Pub. Date: Oct. 22, 2026

(54) Motion Vector Candidate Signaling

(71) Applicant: Google LLC, Mountain View, CA (US)

(72) Inventors: Xiang Li, Saratoga, CA (US); Yaowu Xu, Saratoga, CA (US); Jingning Han, Santa Clara, CA (US)

(21) Appl. No.: 19/113,972

(22) PCT Filed: Dec. 16, 2022
(86) PCT No.: PCT/US2022/053156

§ 371 Date: Mar. 21, 2025

Related U.S. Application Data
(60) Provisional application No. 63/410,260, filed on Sep. 27, 2022.

(51) Int. Cl. H04N 19/139; H04N 19/132; H04N 19/176

(52) U.S. Cl. CPC H04N 19/139; H04N 19/132; H04N 19/176

(57) ABSTRACT

An index of a motion vector candidate of a list of motion vector candidates is decoded from a compressed bitstream. A subset of motion vector candidates to generate is determined based on the index. The subset of motion vector candidates is then generated. The subset of motion vector candidates is a proper subset of the list of motion vector candidates. That is, fewer than all of the motion vector candidates of the list of motion vector candidates are generated. The motion vector candidate is selected from the subset of motion vector candidates based on the index. A current block is decoded using the motion vector candidate.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to motion vector coding candidate signaling.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for decoding a current block. The method also includes decoding, from a compressed bitstream, an index of a motion vector candidate of a list of motion vector candidates; determining a subset of motion vector candidates to generate based on the index. The method also includes generating the subset of motion vector candidates, where the subset of motion vector candidates is a proper subset of the list of motion vector candidates. The method also includes selecting, based on the index, the motion vector candidate from the subset of motion vector candidates. The method also includes decoding the current block using the motion vector candidate. Other embodiments of this aspect include corresponding computer systems, apparatus, and computer programs recorded on one or more computer storage devices, each configured to perform the actions of the methods.

Implementations may include one or more of the following features. The method may include determining that the subset of motion vector candidates is a proper subset of the list of motion vector candidates responsive to determining that a cardinality of the list of motion vector candidates is less than a threshold number of motion vector candidates.

The method may include decoding, from the compressed bitstream, the threshold number of motion vector candidates.

The method may include determining the threshold number of motion vector candidates using a block size of the current block.

Decoding, from the compressed bitstream, the index of the motion vector candidate of the list of motion vector candidates may include decoding, from the compressed bitstream, a codeword indicative of the subset of motion vector candidates; and decoding, from the compressed bitstream, an offset index for the motion vector candidate within the subset of motion vector candidates. The codeword may be decoded using truncated unary coding.

The method may include decoding, from the compressed bitstream, a number of motion vector candidates to generate for the subset of motion vector candidates.

The method may include decoding, from the compressed bitstream, a first number of motion vector candidates corresponding to a first subset of the list of motion vector candidates; and decoding, from the compressed bitstream, a second number of motion vector candidates corresponding to a second subset of the list of motion vector candidates.

Generating the subset of the motion vector candidates may include performing a pruning process so that the subset of the motion vector candidates does not include duplicate motion vector candidates. The subset of motion vector candidates may include another motion vector candidate, and where the another motion vector candidate is a candidate from another subset of motion vector candidates that corresponds to another index that is different from the index.

One general aspect includes a method for encoding a current block. The method may include generating a list of motion vector candidates. The method also includes selecting a reference motion vector from the list of candidate motion vectors. The method also includes encoding, in a compressed bitstream, a codeword indicative of an index of the reference motion vector and indicative of a subset of the motion vector candidates of the list of motion vector candidates. The method also includes encoding, in the compressed bitstream, the current block based on the reference motion vector. Other embodiments of this aspect include corresponding computer systems, apparatus, and computer programs recorded on one or more computer storage devices, each configured to perform the actions of the methods.

Implementations may include one or more of the following features. The method may include encoding, in the compressed bitstream, a threshold number of motion vector candidates.

Encoding, in the compressed bitstream, the codeword may include encoding, in the compressed bitstream, a codeword indicative of the subset of motion vector candidates; and encoding, in the compressed bitstream, an offset index for the motion vector candidate within the subset of motion vector candidates. The codeword may be encoded using truncated unary coding.

The method of any may include encoding, in the compressed bitstream, a number of motion vector candidates to generate for the subset of motion vector candidates.

The method may include encoding, in the compressed bitstream, a first number of motion vector candidates corresponding to a first subset of the list of motion vector candidates; and encoding, in the compressed bitstream, a second number of motion vector candidates corresponding to a second subset of the list of motion vector candidates.

Generating the subset of the motion vector candidates may include performing a pruning process so that the subset of the motion vector candidates does not include duplicate motion vector candidates.

Implementations of the described techniques may include hardware, a method or process, or computer software on a computer-accessible medium.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium may include executable instructions that, when executed by a processor, facilitate performance of operations operable to cause the processor to carry out any of the methods described herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a diagram of motion vectors representing full and sub-pixel motion.

FIG. 7A illustrates an example of generating a group of motion vector candidates for a current block based on spatial neighbors of the current block.

FIG. 7B illustrates an example of generating a group of motion vector candidates for a current block based on temporal neighbors of the current block.

FIG. 7C illustrates an example of generating a group of motion vector candidates for a current block based on non-adjacent spatial candidates of the current block.

FIG. 8 is an example of a flowchart of a technique for decoding a current block.

FIG. 9 is an example of a flowchart of a technique for encoding a current block.

### DETAILED DESCRIPTION

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities is known as inter prediction or motion-compensated prediction (MCP). A prediction block of a current block (i.e., a block being coded) is generated by finding a corresponding block in a reference frame following a motion vector (MV). That is, inter prediction attempts to predict the pixel values of a block using a possibly displaced block or blocks from a temporally nearby frame (i.e., a reference frame) or frames. A temporally nearby frame is a frame that appears earlier or later in time in the video stream than the frame (i.e., the current frame) of the block being encoded (i.e., the current block). A motion vector used to generate a prediction block refers to (e.g., points to or is used in conjunction with) a frame (i.e., a reference frame) other than the current frame. A motion vector may be defined to represent a block or pixel offset between the reference frame and the corresponding block or pixels of the current frame.

The motion vector(s) for a current block in MCP may be encoded into, and decoded from, a compressed bitstream. A motion vector for a current block is described with respect to a co-located block in a reference frame. The motion vector describes an offset (i.e., a displacement) in the horizontal direction (i.e., MVₓ) and a displacement in the vertical direction (i.e., MV_{y}) from the co-located block in the reference frame. As such, an MV can be characterized as a 3-tuple (f, MVₓ, MV_{y}) where f is indicative of (e.g., is an index of) a reference frame, MVₓ is the offset in the horizontal direction from a collocated position of the reference frame, and MV_{y} is the offset in the vertical direction from the collocated position of the reference frame. As such, at least the offsets MVₓ and MV_{y} are written (i.e., encoded) into the compressed bitstream and read (i.e., decoded) from the encoded bitstream. Several coding modes can be used to lower the rate cost of encoding motion vectors.

For example, the SKIP and MERGE modes are two coding modes that use a list of candidate MVs (or, equivalently, other blocks) to reduce the rate of encoding MVs. In the SKIP mode, no residual information is transmitted from an encoder to a decoder. The decoder estimates an MV for a current block encoded using the SKIP mode from a list of candidate MVs and uses (e.g., selects) the MV to calculate a motion-compensated prediction for the current block. In the MERGE mode, an MV from the list of candidate MVs is inherited for coding the current block. The list of candidate MVs may also be referred to as a merge list where the merge list may refer to blocks whose MVs (or, more generally, motion information) are used to select an MV (or, more generally, motion information) for a current block.

As another example, the REFMV and the NEWMV inter prediction modes of the AV1 codec can also be used to lower the rate cost of encoding motion vectors. The REFMV inter-prediction mode indicates that the MV of a current block is a reference MV obtained from a list of candidate MVs. The NEWMV inter prediction mode can be used when the MV for a current block is not a zero MV, and is not any of the candidate MVs. In the NEWMV mode, the MV of the current block may be coded differentially using a reference MV from the list of candidate motion vectors.

As such, and at least as illustrated with respect to some of the coding modes described above, there is generally a need to construct a list of candidate MVs and to code an index of a reference MV (i.e., a selected MV) of the list of candidate MVs. That is, at the encoder, the list of candidate MVs may be constructed according to predetermined rules and the index of a selected MV candidate may be encoded in a compressed bitstream; and, at the decoder, the list of candidate MVs may be constructed (e.g., generated) according to the same predetermined rules and the index of the selected MV candidate may be either inferred or decoded from the compressed bitstream.

In at least some codecs, the index of the reference MV in the list of MV candidates may be coded (i.e., encoded by an encoder and decoded by a decoder) using truncated unary coding. Truncated unary coding can be more efficient for smaller, rather than larger, alphabets. In the case of large alphabets, truncated unary coding leads to more signaling cost when many relatively large indexes are coded. An alphabet, in the context of a list of candidate MVs (or a merge list), refers to all possible index values of MV candidates (or blocks) within the list of candidate MVs.

Truncated unary coding uses codewords to code each of the possible index values. Given a symbol value (val) to be encoded, truncated unary coding may generate a bin string of leading ‘1’s, where the number of ‘1’ is equal to val, followed by a ‘0’, in the case that val<cMax, where cMax is a parameter of the encoding; and in the case that val=cMax, the last ‘0’ is truncated (omitted). To illustrate, assume that cMax=5, then the values 0, 1, 2, 3, 4, and 5 can be encoded as 0, 10, 110, 1110, 11110, and 11111, respectively. Thus, a large number of indexes of the list of candidate motion vectors may lead to high signaling costs when truncated unary coding is used.

The predetermined rules for generating (e.g., deriving, or constructing and ordering) the list of candidate MVs and the number of candidates in the list may vary by codec. For example, in High Efficiency Video Coding (H.265), the list of candidate MVs can include up to 5 candidate MVs.

Codecs may populate the list of candidate MVs using different algorithms, techniques, or tools (collectively, tools). Each of the tools may produce a group of MVs that are added to the list of candidate MVs. For example, in Versatile Video Coding (H.266), the list of candidate MVs may be constructed using several modes, including intra-block copy (IBC) merge, block level merge, and sub-block level merge. The details of these modes are not necessary for the understanding of this disclosure. H.266 limits the number of candidate MVs obtained using IBC merge, block-level merge, and sub-block level merge, to 6 candidates, 6 candidates, and 5 candidates, respectively.

As already alluded to, as the number of candidate MVs increases, the signaling costs of the indexes of selected MVs from the list of candidate MVs also increases. Truncated unary coding is not efficient for signaling the index of a reference MV from the list of candidate MVs when the list includes many candidates. For brevity, the “index of a reference MV from the list of candidate motion vectors” or the “index of a candidate MV of the list of candidate motion vectors” may be referred to herein as a “merge index.” A reference MV, as used herein, refers to the one of the candidate MVs (or, equivalently, the block that uses the candidate MV) that is selected by the encoder and that the decoder is to use to obtain an MV (or, more generally, motion information or parameters) for coding a current block.

Additionally, codecs that use lists of candidate motion vectors, must, in the worst case (i.e., the case that the merge index is the largest index in the list), derive all motion vector candidates of the list of candidates at the decoder. When the number of MV candidates is large (e.g., more than 10 MV candidates), hardware-implemented decoders may not be able to derive all the merge candidates within allotted cycle budgets, especially for high resolution videos.

Implementations according to this disclosure improve the signaling of a reference MV (i.e., a candidate MV) of a list of candidate MVs by dividing the candidate MVs of the list of candidate MVs into subsets of motion vectors. The encoder may encode and a decoder may decode one or more codewords corresponding to the subset of motion vectors. As such, a separate unique codeword is not required for each candidate MV when the list of candidate MVs is treated as or considered to be a long, flat list.

The improved signaling also reduces the need to derive the whole list of candidate MVs at the decoder therewith improving decoder performance. The encoder may encode one or more codewords associated with the reference MV. By decoding the one or more codewords, the decoder can identify the subset of motion vectors that includes the reference MV. As such, the decoder need only generate the candidate MVs of the subset that includes the reference MV. To illustrate, assume that the list of candidate MVs could include a total of 100 candidate MVs, that the first subset in the list of candidate MVs includes 10 candidates, the second subset includes 10 candidates, the third subset includes 15 candidates; and so on. If the codewords decoded from the compressed bitstream indicate that the reference MV is included in the second subset, then the decoder may need only generate the candidates of the second subset. As such, the decoder spends compute cycles generating the 9 candidate MVs instead of all 100 candidates of the list of candidate MVs. In an example, and as further described below, a group of MVs may be split amongst more than one subset. In such cases, the decoder would, at worst, have to generate the group of MVs that spans the subsets, which may be less than generating the full list of candidate MVs.

Further details of motion vector coding using a motion vector precision are described herein with initial reference to a system in which it can be implemented.

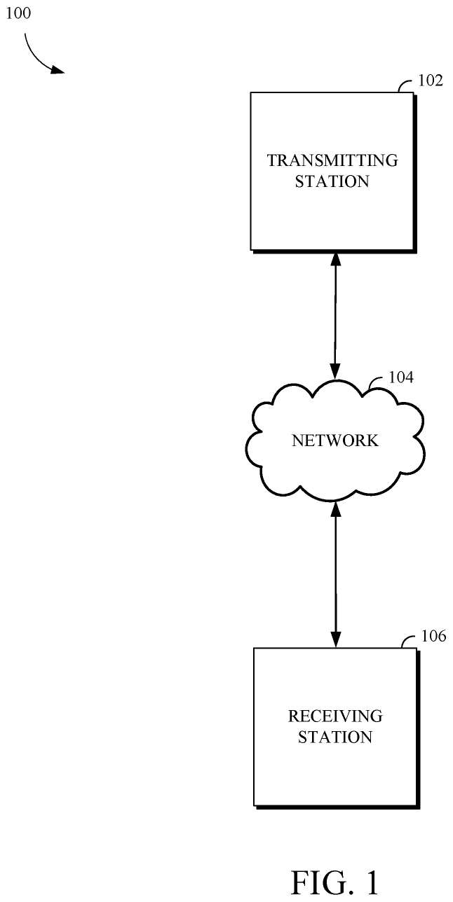

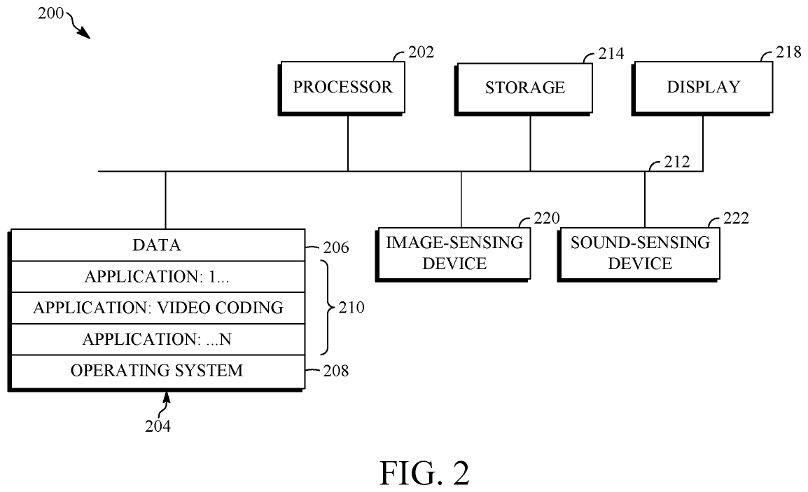

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

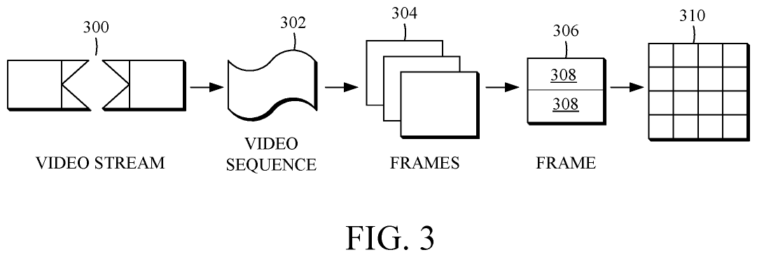

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

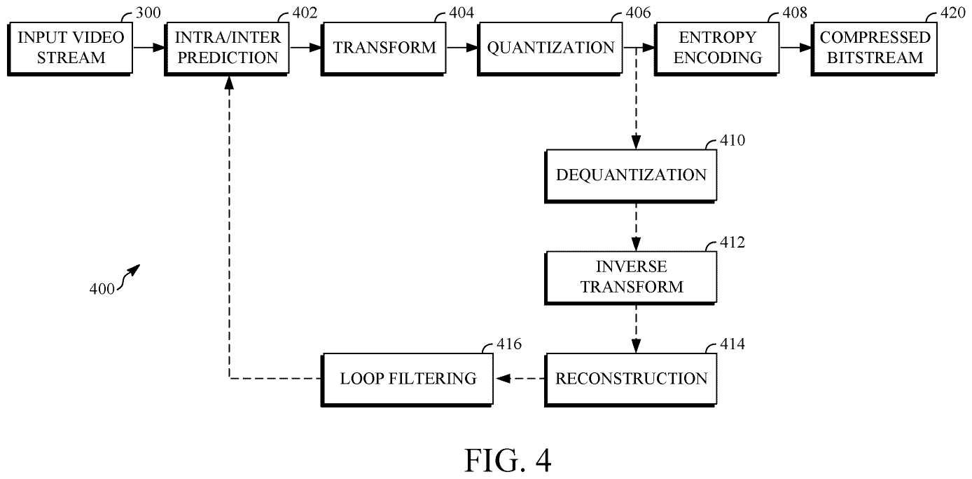

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

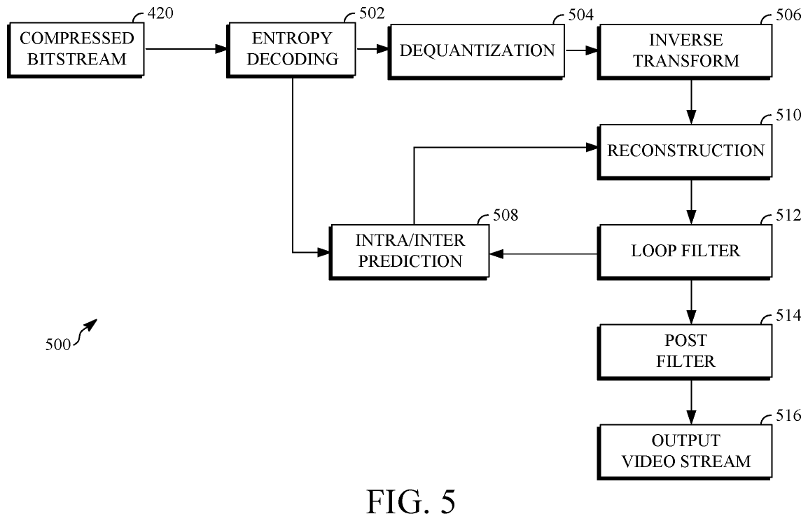

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514.

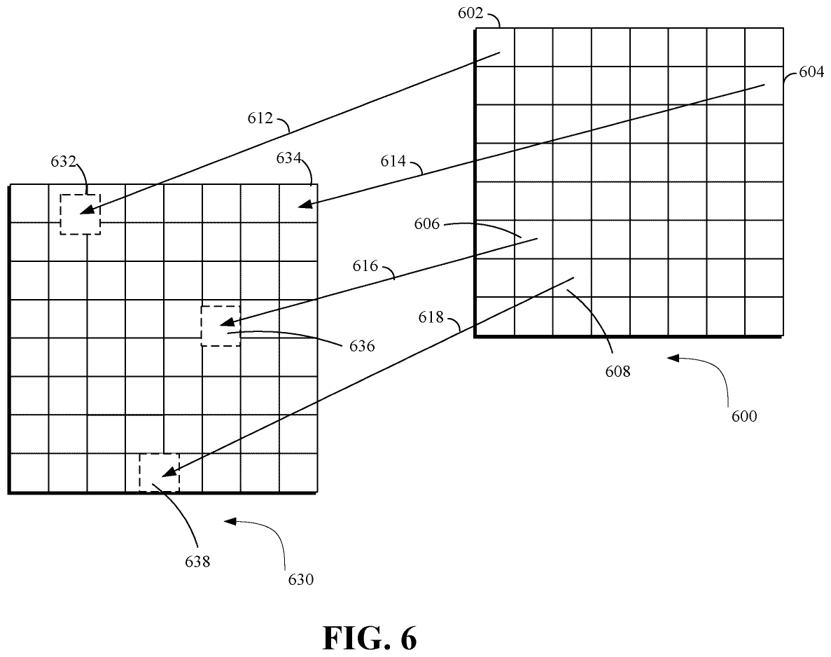

FIG. 6 is a diagram of motion vectors representing full and sub-pixel motion. In FIG. 6, several blocks 602, 604, 606, 608 of a current frame 600 are inter predicted using pixels from a reference frame 630. In this example, the reference frame 630 is a reference frame, also called the temporally adjacent frame, in a video sequence including the current frame 600, such as the video stream 300. The reference frame 630 is a reconstructed frame (i.e., one that has been encoded and decoded such as by the reconstruction path of FIG. 4) that has been stored in a so-called last reference frame buffer and is available for coding blocks of the current frame 600. Other (e.g., reconstructed) frames, or portions of such frames may also be available for inter prediction. Other available reference frames may include a golden frame, which is another frame of the video sequence that may be selected (e.g., periodically) according to any number of techniques, and a constructed reference frame, which is a frame that is constructed from one or more other frames of the video sequence but is not shown as part of the decoded output, such as the output video stream 516 of FIG. 5.

A prediction block 632 for encoding the block 602 corresponds to a motion vector 612. A prediction block 634 for encoding the block 604 corresponds to a motion vector 614. A prediction block 636 for encoding the block 606 corresponds to a motion vector 616. Finally, a prediction block 638 for encoding the block 608 corresponds to a motion vector 618. Each of the blocks 602, 604, 606, 608 is inter predicted using a single motion vector and hence a single reference frame in this example, but the teachings herein also apply to inter prediction using more than one motion vector (such as bi-prediction and/or compound prediction using two different reference frames), where pixels from each prediction are combined in some manner to form a prediction block.

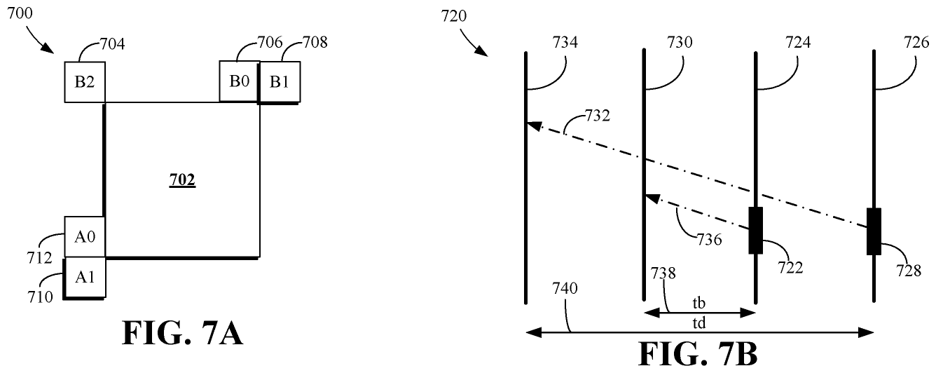

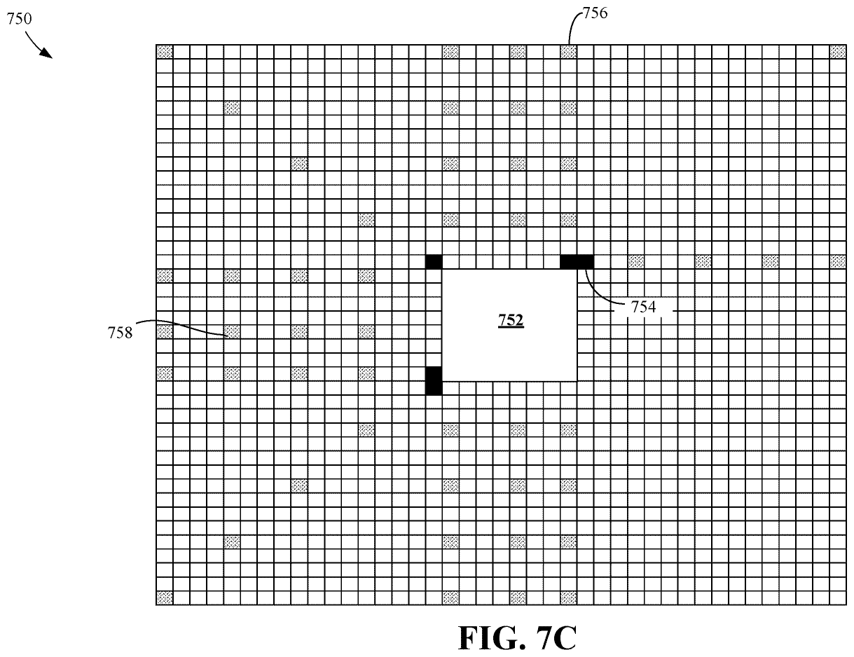

FIGS. 7A-7C illustrate examples of tools for generating groups of motion vectors. As mentioned above, a list of candidate MVs may be obtained using different tools. An encoder, such as the encoder 400 of FIG. 4, and a decoder, such as the decoder 500 of FIG. 5, may use the same tools for obtaining (e.g., populating, constructing, etc.) the same list of candidate MVs. The candidate MVs obtained using a tool are referred to herein as a group of candidate MVs. At least some of the tools described herein may be known or may be similar to or used by other codecs. However, the disclosure is not limited to or by any particular tools that can generate groups of MV candidates.

As mentioned above, merge candidates or candidate MVs may be derived using different tools. Some such tools are now described.

FIG. 7A illustrates an example 700 of generating a group of motion vector candidates for a current block based on spatial neighbors of the current block. The example 700 may be referred to or may be known as generating or deriving spatial merge candidates. The spatial merge mode is limited to merging with spatially-located blocks in the same picture.

A current block 702 may be “merged” with one of its spatially available neighboring block(s) to form a “region.” FIG. 7A illustrates that spatially available neighboring blocks includes blocks 704-712 (i.e., blocks 704, 706, 708, 710, 712). As such, up to six MV candidates (i.e., corresponding to the MVs of the blocks 704-712) may be possible (i.e., added to the list of candidate motion vectors or the merge list). However, more or fewer spatially neighboring blocks may be considered. In an example, a maximum of four merge candidates may be selected from amongst candidate blocks 704-712.

All pixels within the merged region share the same motion parameters (e.g., the same MV(s) and reference frame(s)). Thus, there is no need to code and transmit motion parameters for each individual block of the region. Instead, for a region, only one set of motion parameters is encoded and transmitted from the encoder and received and decoded at the decoder. In an example, a flag (e.g., merge_flag) may be used to specify whether the current block is merged with an available neighboring block. Additionally, an index of the MV candidate in the list of MV candidates of the neighboring block with which the current block is merged.

FIG. 7B illustrates an example 720 of generating a group of motion vector candidates for a current block based on temporal neighbors of the current block. The example 720 may be referred to or may be known as generating or deriving temporal merge candidates or as a temporal merge mode. In an example, the temporal merge mode may be limited to merging with temporally co-located blocks in neighboring frames. In another example, blocks in other frames other than a co-located block may also be used.

A co-located block may be a block that is in a similar position as the current block in another frame. Any number of co-located blocks can be used. That is, the respective co-located blocks in any number of previously coded pictures can be used. In an example, the respective co-located blocks in all of the previously coded frames of the same group of pictures (GOP) as the frame of the current block are used. Motion parameters of the current block may be derived from temporally-located blocks and used in the temporal merge.

The example 720 illustrates that a current block 722 of a current frame 724 is being coded. A frame 726 is a previously coded frame, a block 728 is a co-located block in the frame 726 to the current block 722, and a frame 730 is a reference frame for the current frame. A motion vector 732 is a the motion vector of the block 728. The motion vector 732 points to a reference frame 734. As such, a motion vector 736, which may be a scaled version of the motion vector 732 can be used as a candidate MV for the current block 722. The motion vector 732 can be scaled by a distance 738 (denoted tb) and a distance 740 (denoted td). The distance can be the picture order count (POC) or the display order of the frames. As such, in an example, tb can be defined as the POC difference between the reference frame (i.e., the frame 730) of the current frame (i.e., the current frame 724) and the current frame; and td is defined to be the POC difference between the reference frame (i.e., the reference frame 734) of the co-located frame (i.e., the frame 726) and the co-located frame (i.e., the frame 726).

FIG. 7C illustrates an example 750 of generating a group of motion vector candidates for a current block 752 based on non-adjacent spatial candidates of the current block. A current block 752 illustrates a largest coding unit (which may be further divided into sub-blocks), which may be divided into sub-blocks and where at least some of the sub-blocks may be inter predicted. Blocks that are filled with the black color, such as a block 754, illustrate the neighboring blocks described with respect to FIG. 7A. Blocks filled with the dotted pattern, such as blocks 756, 758 are used for obtaining the group of motion vector candidates for the current block 752 based on non-adjacent spatial candidates.

An order of evaluation of the non-adjacent blocks may be predefined. However, for brevity, the order is not illustrated in FIG. 7C and is not described herein. The group of candidate MVs based on non-adjacent spatial candidates may include 5, 10, fewer, or more MV candidates.

Another example (not illustrated) of generating a group of MV candidates (or merge candidates) for a current block can be history based MV derivation, which may be referred to as history based MV prediction (HMVP) mode.

In the HMVP mode, the motion information of a previously coded block can be stored in a table and used as a candidate MV for a current block. The table with multiple HMVP candidates can be maintained during the encoding/decoding process. The table can be reset (emptied) when a new row of largest coding units (which may be referred to as a superblock or a macroblock) is encountered.

In an example, The HMVP table size may be set to 6, which indicates that up to 6 HMVP candidate MVs may be added to the table. When inserting a new candidate MV into the table, a constrained first-in-first-out (FIFO) rule may be utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table can be checked in order and inserted to the candidate MV list after the temporal merge candidate. A codec may apply redundancy check on the HMVP candidates to the spatial or temporal merge candidate(s).

Yet another example (not illustrated) of generating a group of candidate MVs for a current block can be based on averaging predefined pairs of MV candidates in the already generated groups of MV candidates of the list of MV candidates.

Pairwise average MV candidates can be generated by averaging predefined pairs of candidates in the existing merge candidate list, using motion vectors of already generated groups of MVs. The first merge candidate is defined as p0Cand and the second merge candidate can be defined as p1Cand, respectively. The averaged motion vectors are calculated according to the availability of the motion vector of p0Cand and p1 Cand separately for each reference list. If both motion vectors are available in one list, these two motion vectors can be averaged even when they point to different reference frames, and the reference frame for the average MV can be set to be the same reference frame as that of p0Cand; if only one MV is available, use the one directly; if no motion vector is available, keep this list invalid. Also, if the half-pel interpolation filter indices of p0Cand and p1 Cand are different, the half-pel interpolation filter is set to 0.

In yet another example (not illustrated), a group of zero MVs may be generated. A current reference frame of a current block may use one of N reference frames. A zero MV is a motion vector with displacement (0, 0). The group of zero MVs may include 0 or more zero MVs with respect to at least some of the N reference frames.

It is again noted that the tools described herein for generating groups of candidate MVs does not limit the disclosure in any way and that different codecs may implement such tools differently or may include fewer or more tools for generating candidate MVs or merge candidates.

To summarize, a conventional codec may generate a list of candidate MVs using different tools. Each tool may be used to generate a respective group of candidate MVs. Each group of candidate MVs may include one or more candidate MVs. The candidate MVs of the groups are appended to the list of candidate MVs in a predefined order. The list of candidate MVs has a finite size and the different tools are used until the list is full. For example, the list of candidate MVs may be of size 6, 10, 15, or some other size. For example, spatial merge candidates may be first be added to the list of candidate MVs. If the list is not full, then at least some of temporal merge candidates may be added. If the list is still not full, then at least some of the HMVP candidates may be added. If the list is still not full, then at least some of the pairwise average MV candidates may be added. If the list is still not full, then zero MVs may be added. The size of the list of candidate MVs may be signaled in the compressed bitstream and the maximum allowed size of the merge list may be pre-defined. For each coding unit, an index of the best merge candidate may be encoded using truncated unary binarization. In an example, the first bin of the merge index may be coded with context and bypass coding may be used for other bins.

Additionally, conventional codecs may perform redundancy checks so that a same motion vector is not added more than once at least in the same group of candidate MVs. To illustrate, after the candidate at position A1 of FIG. 7A (i.e., the block 710) is added, the addition of the remaining candidates may be subject to a redundancy check to ensure that candidates with the same motion information are excluded from the list. As another illustration, redundancy checks may be applied on the HMVP candidates with the spatial or temporal merge candidates. In some codecs, and to reduce the number of redundancy check operations, simplifications may be introduced, such as, once the total number of available merge candidates reaches the maximally allowed merge candidates minus 1, the merge candidate list construction process from HMVP is terminated.

Contrastingly, implementations according to this disclosure signal (e.g., encode) the merge index in a multi-subset way when the maximum number of merge candidates is above a threshold such that a decoder need not derive (e.g., generate) all the candidates of the list of candidate MVs. Instead, in the worst case, the decoder only derives the signaled subset of the candidates and/or the candidates of a group of MVs whose MV candidates span (e.g., are divided amongst) subsets. Whereas conventional codecs may generate one list of candidate MVs, candidate MVs according to this disclosure can be thought of as being hierarchically organized. For example, a category (i.e., a subset) of MVs may be coded and other MVs may be coded inside the category.

To illustrate, assume that 100 MV candidates are possible. That is, the list of candidate MVs (i.e., merge list) can include all 100 candidate MVs. Assume further that the coded (e.g., selected by an encoder and decoded by a decoder) MV is the 95^{th} candidate MV. As such, a conventional decoder would at least have to construct the list of candidates of MVs up to the 95^{th} candidate. However, if the 100 candidate MVs is divided into 10 categories, and each containing (for illustration purposes) an equal number of candidate MVs, then the encoder would encode that the selected MV is the 5^{th} MV candidate of the 10^{th} category. At the decoder, the category (10^{th}) and the index (5^{th}) within the category are decoded from the compressed bitstream. As such, the decoder need only construct, at best, a subset of candidates that includes the first 5 candidates of the 10^{th} category, and, at worst, a subset of candidates that includes all 10 candidates of the 10^{th} subset. As such, processing time and memory consumption can be reduced at the decoder.

In an example, the maximum number of candidates may be set to a predefined fixed number that is known to the encoder and the decoder. For example, the maximum number of candidates may be set to 6. In another example, the maximum number of candidates may also be signaled in the compressed bitstream, such as the compressed bitstream 420 of FIG. 4. In an example, the maximum number of candidates may be signaled a sequence parameter set (SPS), a picture parameter set (PPS), a header of a group of pictures (GOP), a frame header, a slice header, or some other grouping of blocks or frames that can be configured to share (e.g., reuse) common coding information (such as motion vectors).

In another example, the maximum number of candidates may be based on the size of the current block (i.e., the size of the block being coded). As such, maximum numbers of candidates by block size may be predefined or may be signaled in the compressed bitstream, such as in an SPS, PPS, a frame header, or block header, or some other grouping of blocks. In an example, the maximum numbers of candidates may be predefined or signaled for two block sizes. To illustrate, if a current block is larger than a first size (e.g., 64×64), then a first maximum number of candidates may be used; and if the current block is smaller than a second size (e.g., 64×64), then a second maximum number of candidates may be used. In an example, the sum of the width and height of a block may be used as the size of the block. In an example, all MVs of a group of candidate MVs may be included in one subset. In an example, a subset of the candidate MVs may correspond to a group of candidate MVs. In an example, at least some of the subsets of the MVs may correspond to respective groups of candidate MVs. In an example, a subset may include less than all of the candidate MVs of a group of candidate MVs. In an example, a subset may include candidate MVs from one or more groups of candidate MVs. In an example, a subset of MVs may include candidate MVs from a group of candidate MVs and may include indications (e.g., indexes) of other subsets of candidate MVs. In an example, a subset of MVs may include candidate MVs from a group of candidate MVs and may include indications (e.g., indexes) of other groups of candidate MVs.

In an example, different signaling techniques may be used for different subsets. For example, the first subset may be signaled together with indexes of other subsets. The first subset and the indexes of other subsets can be coded using truncated unary coding. Any number of subsets can be used. Any number of MVs can be included in a subset.

To illustrate, 4 subsets can be used and the first subset can include 6 candidates. As mentioned, the first subset may be signaled together with indexes of other subsets. As such, a total of 9 (6+3=9) different possible indexes may be signaled. The first 6 indexes are for the candidate MVs of the first subset and the last 3 indexes indicate, respectively, the other 3 subsets. In an example, the 9 indexes can be coded with the truncated unary coding. However, other entropy coding techniques are possible. For candidate MVs that are not in the first subset, after signaling the index of the subset, the index of the candidate MV within the subset is further signaled. Any entropy coding technique can be used. For example, truncated unary coding, fixed length coding, exponential Golomb coding, or other coding techniques may be used for a subset other than the first subset.

In an example, different subsets may have different numbers of candidates. In an example, the numbers may be predefined; in another example, the numbers may be signaled in compressed bitstreams, such as in SPS, PPS, picture header, slice header, or some other grouping of blocks.

As mentioned above, conventional codecs may perform pruning. In implementations according to this disclosure, pruning may also be used to avoid duplicated candidate MVs. However, pruning does not cross subsets so that each subset may be constructed independently. As such, different subsets may have overlap in MV candidates to compensate for the potential inefficiency of not allowing pruning across subsets.

Using subsets of MV candidates to signal a selected candidate MV (i.e., to signal an index therefore) is now described using an illustrative example. In the illustrative example, a first group of up to 5 candidate MVs may be obtained based on spatial neighbors of a current block, as described with respect to FIG. 7A; a second group of up to 1 candidate MVs may be obtained based on temporal neighbors of the current block, as described with respect to FIG. 7B; a third group of up to 18 candidate MVs may be obtained based on non-adjacent spatial candidates, as described with respect to FIG. 7C; a fourth group of up to 5 candidate MVs may be obtained using the HMVP mode, as described above; a fifth group of up to 1 candidate MVs may be obtained using pairwise average MV candidates, as described above; and a sixth group of up to 1 zero MV candidate may be obtained, as described above.

The candidate MVs may be divided into a first number of subsets for current blocks that are larger than a first size (e.g., a threshold size) and may be divided into a second number of subsets for current blocks that are smaller than a second size (e.g., the threshold size). To illustrate, the candidate MVs may be divided into 2 subsets for (i.e., luma) blocks that are larger than 64×64, and into 4 subsets for blocks that are smaller than 64×64. For smaller blocks (e.g., blocks smaller than the threshold size), a decoder may be limited, such as an average cycle budget allocated for merge list construction, to a fewer number of MV candidates than the maximum numbers listed above in each subset to reduce the cycles.

Table I illustrates codewords that can be used for a first subset for blocks no larger than the threshold size (e.g., 64×64 luma blocks). The first subset (i.e., subset 1) includes candidate positions from the first group and the second group. Up to 4 candidates may be allowed in the first subset after pruning. Truncated unary coding with maximum number of 7 is used to signal the candidates in the first subset and the indexes of other subsets. As such, if the selected MV is the very MV of the first subset, then the encoder encodes, and the decoder decodes, the codeword 0 corresponding to index 0; if the selected MV is the third MV candidate of the first group, then the encoder encodes, and the decoder decodes, the codeword 110 corresponding to the third MV candidate of the subset; if the selected MV is in subset 3, then the encoder first encodes, and the decoder first decodes, the codeword 111110 indicating that the selected MV is in the third subset; and so on.

TABLE I

| Codeword | Description of Codeword |
|---|---|
| 0 | 1st candidate in subset 1 |
| 10 | 2nd candidate in subset 1 |
| 110 | 3rd candidate in subset 1 |
| 1110 | 4th candidate in subset 1 |
| 11110 | subset 2 |
| 111110 | subset 3 |
| 111111 | subset 4 |

If the selected MV is in a subset other than the first subset, then another codeword is coded to indicate the specific MV candidate withing that subset. In an example, the second subset (e.g., subset 2) may include candidate positions from the second group and the first 10 positions of the third group. In an example, up to 5 candidates may be allowed in the second subset after pruning. In an example, truncated unary coding with the maximum number of 5 may be used to signal the selected MV candidate in the second subset. In an example, the third subset (i.e., subset 3) may include candidate positions from the last 10 positions of the third group and the MV candidates of the fourth group. In an example, up to 5 candidates may be allowed in the third subset after pruning. In an example, truncated unary coding with the maximum number of 5 may be used to signal the selected MV candidate in the third subset. In an example, the fourth subset (e.g., subset 4) may include candidate positions from the third, fourth, and fifth groups. In an example, up to 5 candidates may be allowed in the fourth subset after pruning. In an example, truncated unary coding with the maximum number of 5 may be used to signal the selected MV candidate in the fourth subset.

Table II illustrates codewords that can be used for a first subset for blocks that are at least equal in size to the threshold size (e.g., 64×64 luma blocks). The first subset (i.e., subset 1) includes candidate positions from the first group, the second group, and third group. Up to 6 candidates may be allowed in the first subset after pruning. Truncated unary coding with maximum number of 7 can be used to signal the candidates in the first subset and the index of the second subset. As such, if the selected MV is the very MV of the first subset, then the encoder encodes, and the decoder decodes, the codeword 0 corresponding to index 0; if the selected MV is the third MV candidate of the first group, then the encoder encodes, and the decoder decodes, the codeword 110 corresponding to the third MV candidate of the subset; if the selected MV is in subset 2, then the encoder first encodes, and the decoder first decodes, the codeword 111111 indicating that the selected MV is in the second subset; and so on.

TABLE II

| Codeword | Description of Codeword |
|---|---|
| 0 | 1st candidate in subset 1 |
| 10 | 2nd candidate in subset 1 |
| 110 | 3rd candidate in subset 1 |
| 1110 | 4th candidate in subset 1 |
| 11110 | 5th candidate in subset 1 |
| 111110 | 6th candidate in subset 1 |
| 111111 | subset 2 |

If the selected MV is in the subset, then another codeword is coded to indicate the specific candidate MV of the second subset. In an example, the second subset (e.g., subset 2) may include candidate positions from the third, fourth, fifth, and sixth groups. In an example, up to 6 candidates may be allowed in the second subset after pruning. In an example, truncated unary coding with the maximum number of 6 may be used to signal the selected MV candidate in the second subset.

To further describe some implementations in greater detail, reference is next made to examples of techniques which may be performed for decoding and encoding an index of a reference motion vector candidate.

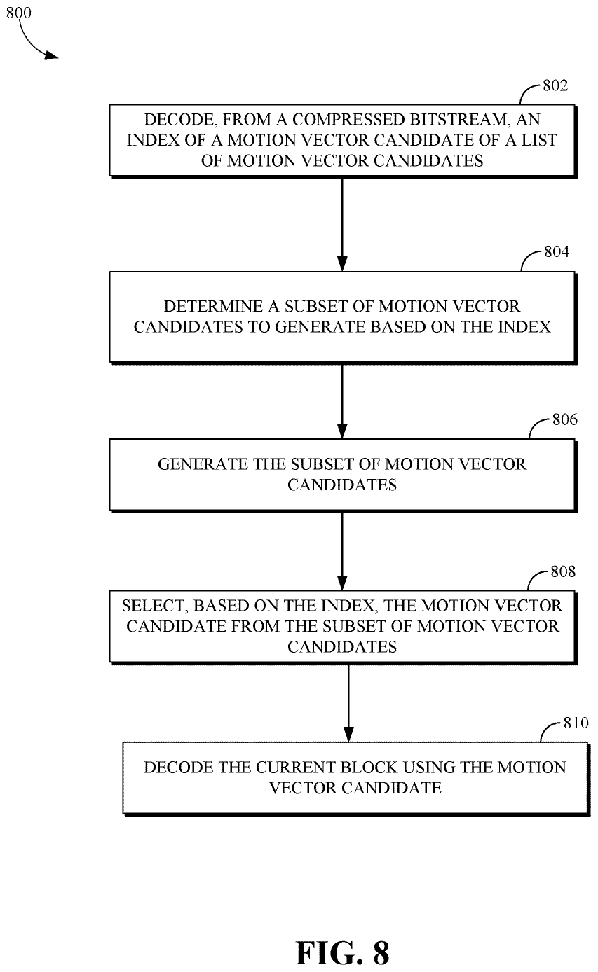

FIG. 8 is an example of a flowchart of a technique 800 for decoding a current block. The technique 800 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 800. The technique 800 may be implemented in whole or in part in the intra/inter prediction stage 508 of the decoder 500 of FIG. 5. The technique 800 can be implemented using specialized hardware or firmware. Multiple processors, memories, or both, may be used.

At 802, an index of a motion vector candidate of a list of motion vector candidates is decoded from a compressed bitstream, such as the bitstream 420 of FIG. 5. Decoding an index of a motion vector candidate can include decoding a codeword indicative of the index of the motion vector candidate. As mentioned above, if the candidate MV is not in the first subset and the candidate MV is in other than the first subset, then the decoder decodes a codeword corresponding to the subset and a codeword indicative of the index of the candidate MV within the subset. As such, in an example, decoding the index of the motion vector candidate of a list of motion vector candidates can include decoding, from the compressed bitstream, a codeword indicative of the subset of motion vector candidates; and decoding, from the compressed bitstream, an offset index for the motion vector candidate within the subset of motion vector candidates. In an example, truncated unary coding can be used to decode the codeword.

An encoder may have encoded the index of the motion vector candidate in the compressed bitstream. In an example, the encoder may have generated the list of candidate MVs (or merge list). Determined, such as based on a rate-distortion analysis that the motion vector candidate provides the best rate-distortion value and, accordingly, encoded the current block using the motion vector candidate, which includes encoding the index of the motion vector candidate in the compressed bitstream.

At 804, the decoder determines what subset of motion vector candidates to generate based on the index. At 806, the subset of motion vector candidates is generated (e.g., derived or obtained). As mentioned above, the subset of motion vector candidates is a proper subset of the list of motion vector candidates. That is, the subset of motion vector candidates is smaller than the full list of candidate MVs that is possible and it typically generated by a conventional decoder. In an example, a number of motion vector candidates to generate for the subset of motion vector candidates can be decoded from the compressed bitstream. In an example, the generated subset of motion vector candidates is such that it does not include duplicate motion vector candidates. A pruning process may be performed after the subset of motion vector candidates is generated or may be performed as the subset of motion vector candidates is being generated.

At 808, the motion vector candidate is selected from the subset of motion vector candidates based on the index. At 810, the current block is decoded using the motion vector candidate.

In an example, the technique 800 can determine that the subset of motion vector candidates is a proper subset of the list of motion vector candidates responsive to determining that the cardinality of the list of motion vector candidates is less than a threshold number of motion vector candidates. In an example, the threshold number of motion vector candidates can be decoded from the compressed bitstream. In an example, the threshold number of motion vector candidates can be determined using a block size of the current block.

In an example, the technique 800 can include decoding, from the compressed bitstream, a first number of motion vector candidates corresponding to a first subset of the list of motion vector candidates; and decoding, from the compressed bitstream, a second number of motion vector candidates corresponding to a second subset of the list of motion vector candidates.

In an example, the subset of motion vector candidates can include a motion vector candidate that is a candidate for another subset of motion vector candidates that corresponds to another index that is different from the index. That is, and as mentioned above, different subsets may have overlap in MV candidates to compensate for the potential inefficiency of not allowing pruning across subsets. To illustrate, a first subset may include motion vector candidate indexes 1-5, a second subset may include motion vector candidate indexes 6-13, and a third subset may include motion vector candidate indexes 9-18. As such, the second and third subsets include overlapped candidates 9-13.

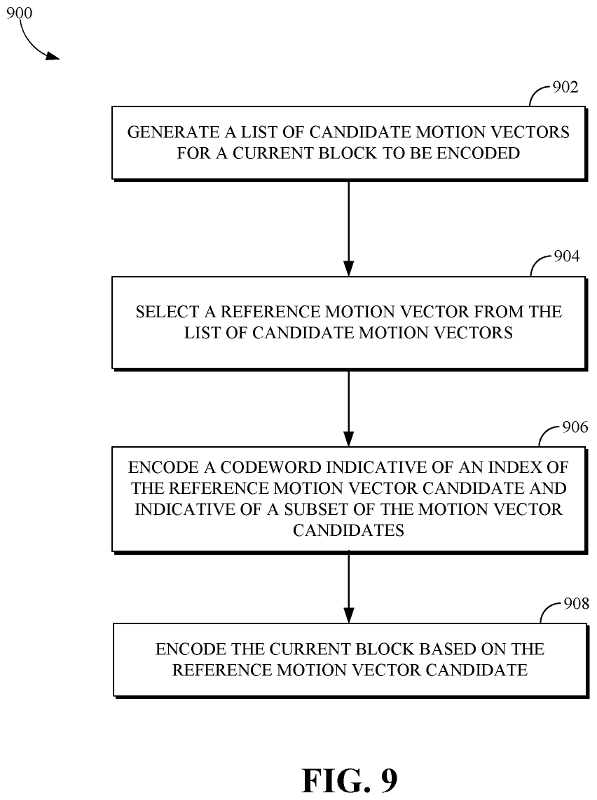

FIG. 9 is an example of a flowchart of a technique 900 for encoding a current block. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 900. The technique 900 may be implemented in whole or in part in the intra/inter prediction stage 402 of the encoder 400 of FIG. 4. The technique 900 can be implemented using specialized hardware or firmware. Multiple processors, memories, or both, may be used.

The technique 900 may receive a current block to be encoded and may determine that the current block is to be encoded using inter-prediction. As described herein, at 902, a list of candidate motion vectors may be generated. At 904, one of the candidate motion vectors may be selected as a reference motion vector. That is, the current block is to be encoded based on the reference motion vector. As mentioned above, the encoder may select the candidate motion vector based on a rate-distortion analysis that the reference motion vector provides the best rate-distortion value. At 906, a codeword indicative of an index of the reference motion vector and indicative of a subset of the motion vector candidates of the list of motion vector candidates is encoded in a compressed bitstream, such as the compressed bitstream 420 of FIG. 4. At 908, the current block is encoded using the reference motion vector, which can be as described herein.

While not specifically shown in FIG. 9, the list of candidate motion vectors may be partitioned into subsets of motion vectors, as described above. Encoding the index of the reference motion vector can include encoding a codeword indicative of the index of the reference motion vector. As mentioned above, if the reference candidate MV is not in the first subset and is in other than the first subset, then the encoder encodes a codeword corresponding to the subset and a codeword indicative of the index of the candidate MV within the subset. As such, in an example, encoding the index of the motion vector candidate of a list of motion vector candidates can include encoding, into the compressed bitstream, a codeword indicative of the subset of motion vector candidates; and encoding, in the compressed bitstream, an offset index for the motion vector candidate within the subset of motion vector candidates. As mentioned above, truncated unary coding can be used to encode the codeword. In an example, and as described above, to simplify processing at a decoder, the encoder may not prune candidate motion vector candidates obtained using different techniques.

As described above, in an example, the technique 900 may include encoding, into the compressed bitstream, respective numbers of candidate motion vectors for at least some of the subsets of candidate motion vectors.

For simplicity of explanation, the techniques described herein, such as the technique 800 of FIG. 8 and the technique 900 of FIG. 9, are depicted and described as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method for decoding a current block, comprising:
decoding, from a compressed bitstream, an index of a motion vector candidate of a list of motion vector candidates;
determining a subset of motion vector candidates to generate based on the index;
generating the subset of motion vector candidates, wherein the subset of motion vector candidates is a proper subset of the list of motion vector candidates;
selecting, based on the index, the motion vector candidate from the subset of motion vector candidates; and
decoding the current block using the motion vector candidate.

2. The method of claim 1, comprising:
determining that the subset of motion vector candidates is a proper subset of the list of motion vector candidates responsive to determining that a cardinality of the list of motion vector candidates is less than a threshold number of motion vector candidates.

3. The method of claim 2, comprising:
decoding, from the compressed bitstream, the threshold number of motion vector candidates.

4. The method of claim 2, comprising:
determining the threshold number of motion vector candidates using a block size of the current block.

5. The method of claim 1, wherein decoding, from the compressed bitstream, the index of the motion vector candidate of the list of motion vector candidates comprises:
decoding, from the compressed bitstream, a codeword indicative of the subset of motion vector candidates; and
decoding, from the compressed bitstream, an offset index for the motion vector candidate within the subset of motion vector candidates.

6. The method of claim 5, wherein the codeword is decoded using truncated unary coding.

7. The method of claim 1, comprising:
decoding, from the compressed bitstream, a number of motion vector candidates to generate for the subset of motion vector candidates.

8. The method of claim 1, comprising:
decoding, from the compressed bitstream, a first number of motion vector candidates corresponding to a first subset of the list of motion vector candidates; and
decoding, from the compressed bitstream, a second number of motion vector candidates corresponding to a second subset of the list of motion vector candidates.

9. The method of claim 1, wherein generating the subset of the motion vector candidates comprises:
performing a pruning process so that the subset of the motion vector candidates does not include duplicate motion vector candidates.

10. The method of claim 1, wherein the subset of motion vector candidates includes an other motion vector candidate, and wherein the other motion vector candidate is a candidate from another subset of motion vector candidates that corresponds to another index that is different from the index.

11. A method for encoding a current block, comprising:
generating a list of motion vector candidates;
selecting a reference motion vector from the list of candidate motion vectors;
encoding, in a compressed bitstream, a codeword indicative of an index of the reference motion vector and indicative of a subset of the motion vector candidates of the list of motion vector candidates; and
encoding, in the compressed bitstream, the current block based on the reference motion vector.

12. The method of claim 11, comprising:
encoding, in the compressed bitstream, a threshold number of motion vector candidates.

13. The method of claim 11, wherein encoding, in the compressed bitstream, the codeword comprises:
encoding, in the compressed bitstream, a codeword indicative of the subset of motion vector candidates; and
encoding, in the compressed bitstream, an offset index for the motion vector candidate within the subset of motion vector candidates.

14. The method of claim 11, wherein the codeword is encoded using truncated unary coding.

15. The method of claim 11, comprising:
encoding, in the compressed bitstream, a number of motion vector candidates to generate for the subset of motion vector candidates.

16. The method of claim 11, comprising:
encoding, in the compressed bitstream, a first number of motion vector candidates corresponding to a first subset of the list of motion vector candidates; and
encoding, in the compressed bitstream, a second number of motion vector candidates corresponding to a second subset of the list of motion vector candidates.

17. The method of claim 11, wherein generating the subset of the motion vector candidates comprises:
performing a pruning process so that the subset of the motion vector candidates does not include duplicate motion vector candidates.

18. A device, comprising:
a processor configured to execute the method of claim 1.

19. A device, comprising:
a memory; and
a processor, wherein the memory stores instructions operable to cause the processor to carry out the method of claim 11.

20. A non-transitory computer-readable storage medium, comprising an encoded bitstream arranged to be decoded according to a method comprising:
decoding, from a compressed bitstream, an index of a motion vector candidate of a list of motion vector candidates for a current block;
determining a subset of motion vector candidates to generate based on the index;
generating the subset of motion vector candidates, wherein the subset of motion vector candidates is a proper subset of the list of motion vector candidates;
selecting, based on the index, the motion vector candidate from the subset of motion vector candidates; and
decoding the current block using the motion vector candidate.
